(19) United States
(12) Patent Application Publication
(10) Pub. No.: US 2011/0261992 A1
(43) Pub. Date: Oct. 27, 2011

(54) MAGNETIC CIRCUIT UNIT AND SPEAKER USING SAME

(76) Inventors: Xing-Zhi HUANG, Shenzhen (CN); Li-Shu Xi, Shenzhen (CN); Wei Zhu, Shenzhen (CN)

(21) Appl. No.: 12/978,582

(22) Filed: Dec. 26, 2010

(30) Foreign Application Priority Data
Apr. 27, 2010 (CN) 201020178688.X

(51) Int. Cl. H04R 1/00; H01F 7/02

(52) U.S. Cl. 381/420; 335/306

(57) ABSTRACT

A magnetic circuit unit includes a yoke, a magnet positioned on the yoke, a plate on the magnet. The yoke includes a bottom defining a central hole therein, and a wall extending from the bottom. The magnet is positioned on the bottom of the yoke. The plate defines a base coupled to a top surface of the magnet, and a central pole extending from the base and getting through the annular magnet with an end thereof suspended in the central hole of the yoke. Thus, a first magnetic gap is formed between the wall of the yoke and an outer side of the annular magnet, and a second magnetic gap is formed between the central pole of the plate and an inner side of the annular magnet. A speaker using the magnetic circuit unit described above is disclosed.

### FIELD OF THE INVENTION

The present invention generally relates to the art of speakers, and more particularly, to a speaker having dual magnetic circuits.

### RELATED ART OF THE INVENTION

Speakers are widely used in many types of portable electronic devices, such as mobile phones, notebook computers, hearing aids, for converting audio electrical signals to audible sounds.

Generally, a traditional speaker includes one magnetic circuit. The magnetic circuit of the traditional speaker includes only one yoke, only one magnet assembled in the yoke with only one plate attached to a surface thereof, is only one magnetic gap formed between the yoke and the magnet together with the plate. Corresponding with the magnet circuit, only one coil suspended in the magnetic gap and only one diaphragm coupled to the coil are provided in the traditional speaker.

In order to improve the performance of traditional speakers, based on the one-magnetic-circuit structure, dual-magnetic-circuit structures were developed, as disclosed in US patent application Pub. NO.2009-0279729A1. The dual-magnetic-circuit structure typically includes two magnets. However, the mount of the components used in a dual-magnetic-circuit speaker is increased. Further, each magnet needs to be magnetized, which increases the cost of manufacture.

Therefore, an improved speaker that can resolve the problems mentioned-above is desired.

### BRIEF DESCRIPTION OF THE DRAWINGS

FIG. 1 depicts an isometric view of a speaker in accordance with one exemplary embodiment of the present invention;

FIG. 2 depicts a cross-sectional view of the speaker in FIG. 1;

FIG. 3 depicts an isometric exploded view of the speaker in FIG. 1.

### DETAILED DESCRIPTION OF THE EXEMPLARY EMBODIMENT

Reference will now be made to describe one exemplary embodiment of the present invention in detail.

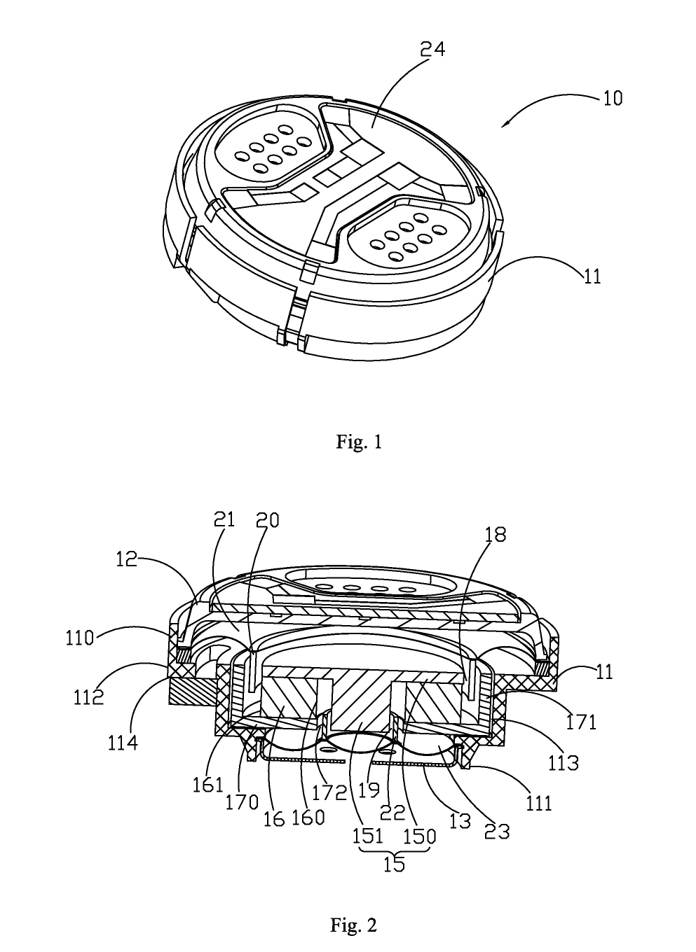

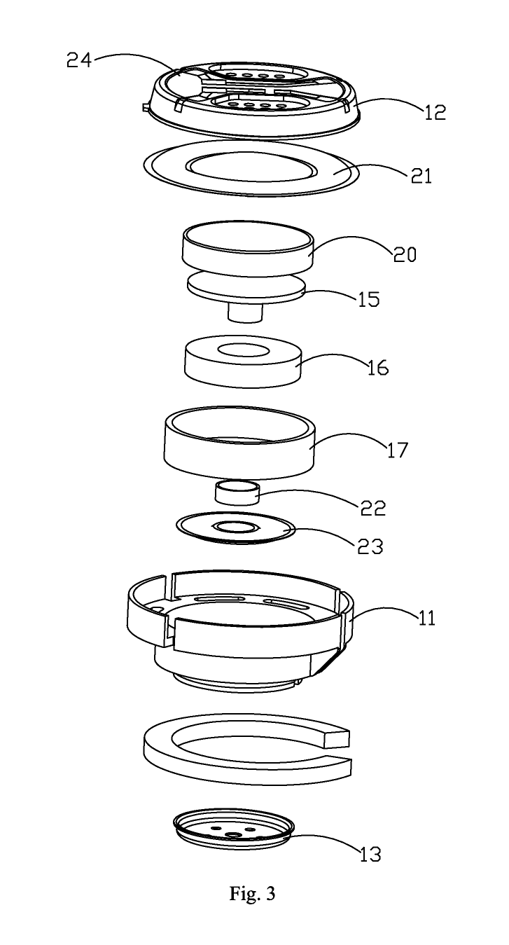

Referring to FIGS. 1-3, a speaker 10, in accordance with an exemplary embodiment of the present invention, includes a magnetic circuit unit, a vibrating unit, a case 11 together with an upper cover 12 and a lower cover 13 for receiving the magnetic circuit unit and the vibrating unit therein.

The case 11 defines a cavity 113, an upper end 110 coupled to the upper cover 12, and a lower end 111 opposite to the upper end 110 for being coupled to the lower cover 13, whereby, a receiving space is formed by the case 11 together with the upper cover 12 and the lower cover 13, for receiving the magnetic circuit unit and the vibrating unit therein.

The magnetic circuit unit includes a yoke 17 accommodated in the cavity 113, an annular magnet 16 positioned on a bottom 170 of the yoke 17, a plate 15 attached to a top surface of the magnet 16. The magnetic circuit unit is used for providing substantially closed magnetic field. The yoke 17 further defines a wall 171 extending from the bottom 170.

The plate 15 defines a base 150 and a central pole 151 located on a central part of the base 150. The annular magnet 16 defines an inner side 160 and an outer side 161. The bottom 170 of the yoke 17 defines a central hole 172 therein.

Both of the annular magnet 16 and the plate 15 are received in the yoke 17. While assembled, the base 150 of the plate 15 is attached to the top is surface of the annular magnet 16, and the central pole 151 is received in a channel formed by the inner side 160 of the annular magnet 16 with an end thereof suspended in the central hole 172 of the yoke 17. In other words, the central pole 151 of the plate 15 gets through the annular magnet 16 and the central hole 172 of the yoke 17. Furthermore, a diameter of the base 150 of the plate 15 is preferably equal to an outer diameter of the annular magnet 16, and a diameter of the central hole 172 of the yoke 17 is preferably equal to an inner diameter of the annular magnet 16.

A surface of the annular magnet 16 is coupled to the base 150 of the plate 15, and another surface of the annular magnet 16 is coupled to the bottom 170 of the yoke 17. And, the inner side 160 of the annular magnet 16 surrounds the central pole 151 of the plate 15 and an end of the central pole 151 is suspended in the central hole 172 of the yoke 17. In other words, the central pole 151 of the plate 15 gets through the annular magnet 16 and the central hole 172 of the yoke 17. Furthermore, a diameter of the base 150 of the plate 15 is preferably equal to an outer diameter of the annular magnet 16, and a diameter of the central hole 172 of the yoke 17 is preferably equal to an inner diameter of the annular magnet 16.

A first magnetic gap 18 is formed between the wall 171 of the yoke 17 and the outer side 161 of the annular magnet 16 together with the base 150 of the plate 15. A second magnetic gap 19 is formed between the central pole 151 of the plate 15 and the inner side 160 of the annular magnet 16 together with a sidewall of the central hole 172 of the yoke 17.

The vibrating unit includes a first coil 20, a first diaphragm 21 coupled to the first coil 20, a second coil 22, and a second diaphragm 23 coupled to the second coil 22. while assembled, the first coil 20 is suspended in the first magnetic gap 18 and a periphery edge of the first diaphragm 21 is fixed to the upper end 110 of the case 11, while, the second coil 22 is suspended in the second magnetic gap 19 and a periphery edge of the second diaphragm 23 is fixed to the lower end 111 of the case 11.

A PCB 24 is provided on an outer surface of the upper cover 12. Circuit of the PCB 24 provides acoustic frequency signals to the first coil 20 and the second coil 22. Conventionally, acoustic frequency signals involve high frequency signals and low frequency signals. The high frequency signals and low frequency signals can be synchronously provided to the first coil and the second coil, respectively. Therefore, the acoustic frequency of the low frequency signals and the high frequency signals can be both output synchronously, which effectively solves the problem of intermodulation of distortion for the high and low acoustic frequencies, and reduces the size of the speaker to be more compact.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A magnetic circuit unit, comprising:
a yoke including a bottom defining a central hole therein, and a wall extending from the bottom;
an annular magnet positioned on the bottom of the yoke;
a plate defining a base coupled to a top surface of the annular magnet, and a central pole extending from the base and getting through the annular magnet with an end thereof suspended in the central hole of the yoke;
a first magnetic gap formed between the wall of the yoke and an outer side of the annular magnet;
a second magnetic gap formed between the central pole of the plate and an inner side of the annular magnet.

2. The magnetic circuit unit as described in claim 1, wherein a diameter of the base of the plate is substantially equal to an outer diameter of the annular magnet.

3. The magnetic circuit unit as described in claim 1, wherein a diameter of the central hole of the yoke is substantially equal to an inner diameter of the annular magnet.

4. A speaker, comprising:
a case defining an upper end and a lower end opposed to the upper end for forming a cavity;
a magnetic circuit unit comprising:
a yoke comprising a bottom defining a central hole therein, and a wall extending from the bottom;
an annular magnet positioned on the bottom of the yoke;
a plate defining a base coupled to a top surface of the annular magnet, and a central pole extending from the base and getting through the annular magnet with an end thereof suspended in the central hole of the yoke;
a first magnetic gap formed between the wall of the yoke and an outer side of the annular magnet;
a second magnetic gap formed between the central pole of the plate and an inner side of the annular magnet;
a first coil suspended in the first magnetic gap;
a first diaphragm coupled to the first coil with a periphery edge fixed to the upper end of the case;
a second coil suspended in the second magnetic gap; and
a second diaphragm coupled to the second coil with a periphery edge fixed to the lower end of the case.

5. The speaker as described in claim 4, wherein a diameter of the base of the plate is substantially equal to an outer diameter of the annular magnet.

6. The speaker as described in claim 4, wherein a diameter of the central hole of the yoke is substantially equal to an inner diameter of the annular magnet.

7. The speaker as described in claim 4 further comprising an upper cover assembled with the upper end of the case.

8. The speaker as described in claim 7 further comprising a lower cover assembled with the lower end of the case.

9. A magnetic circuit unit for a speaker, comprising:
a first plate;
a second plate opposed from the first plat, the second plate defining a central to hole in a middle portion thereof;
a permanent magnet positioned between the first plate and the second plate, the magnet defining an outer side and an inner side, the inner side forming a channel;
a wall surrounding the outer side of the magnet;
a pole extending from the first plate toward the second plate via the channel with an end thereof suspended in the central hole of the second plate;
a first magnetic gap formed between the wall and the outer side of the magnet; and
a second magnetic gap formed between the inner side and the pole.
